(19) United States
(12) Patent Application Publication
(10) Pub. No.: US 2021/0110120 A1
(43) Pub. Date: Apr. 15, 2021

(54) MESSAGE PROCESSING METHOD, DEVICE AND TERMINAL DEVICE

(71) Applicant: Dingtalk Holding (Cayman) Limited, Gand Cayman (KY)

(72) Inventors: Yi Zhang, Hangzhou (CN); Jie Ke, Shangzhou (CN); Jiabao Wan, Shangzhou (CN); Guodi Ge, Shangzhou (CN); Qian Chen, Shangzhou (CN)

(21) Appl. No.: 17/127,663

(22) Filed: Dec. 18, 2020

Related U.S. Application Data
(63) Continuation of application No. PCT/CN2019/090505, filed on Jun. 10, 2019.

(30) Foreign Application Priority Data
Jun. 20, 2018 (CN) 201810638361.7

(51) Int. Cl. G06F 40/58; G06F 40/263; G06F 40/166; H04L 12/58

(52) U.S. Cl. CPC G06F 40/58; H04L 51/046; G06F 40/166; G06F 40/263

(57) ABSTRACT

A method including in response to a determination result of language inconsistency between two parties of a conversation, starting a translation, which is used for implementing the translation of a first language into a second language; if an original message input by a first user in a first language in the conversation interface is received, obtaining a translation message of the second language corresponding to the original message; displaying the translation message in the conversation interface. Since the input and translation processing of the original message are performed simultaneously, the influence of the translation time on the efficiency of communication between both parties is reduced.

### CROSS REFERENCE TO RELATED APPLICATIONS

This application claims priority to and is a continuation of PCT Patent Application No. PCT/CN2019/090505, filed on 10 Jun. 2019 and entitled “MESSAGE PROCESSING METHOD, DEVICE AND TERMINAL DEVICE,” which claims priority to Chinese Patent Application No. 201810638361.7, filed on 20 Jun. 2018 and entitled “MESSAGE PROCESSING METHOD, DEVICE AND TERMINAL DEVICE,” which are incorporated herein by reference in their entirety.

### TECHNICAL FIELD

The present disclosure relates to the field of instant messaging technology, and, more particularly, to message processing methods, devices and terminal devices.

### BACKGROUND

In order to facilitate communication between users, various instant messaging applications (APP) have been developed. In addition, the demand for communication between users using different languages has become increasingly popular, requiring instant messaging APPs to provide a translation function between different languages.

At present, a more popular implementation is that after a receiver receives a message sent by a sender, if the receiver finds that he/she does not understand the language used in the message and thus has a demand for translation, the receiver may invoke the translation function provided by the instant messaging APP to translate the message into the language he uses.

In this way, after the receiver receives a message sent by the sender, the receiver needs to translate the received message through the translation function of the instant messaging APP and then obtain a translation message that the receiver can understand. The translation process takes time, which undoubtedly affects the timeliness for the receiver to learn the message. That is, this translation process often causes a delay in the display of the message (translated message), which reduces the efficiency of communication between the two parties of a conversation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The embodiments of the present disclosure provide message processing methods, devices and terminal devices to raise the efficiency of communication between the parties of a conversation.

An embodiment of the present disclosure provides a message processing method, comprising:

in response to a determination result of language inconsistency between two parties of a conversation, starting a translation function, which is used for implementing the translation of a first language into a second language;

in response to receiving an original message input by a first user in the first language, obtaining a translation message of the second language corresponding to the original message;

and displaying the translation message in a conversation interface.

For example, the original message may be input by the first user and displayed at the conversation interface.

An embodiment of the present disclosure provides a message processing device, comprising:

a starting module, used for starting a translation function, which is used for implementing the translation of a first language into a second language, in response to a determination result of language inconsistency between two parties of a conversation;

an obtaining module, used for, in response to receiving an original message input by a first user in the first language, obtaining a translation message of the second language corresponding to the original message; and

a displaying module, used for displaying the translation message in the conversation interface.

For example, the original message may be input by the first user and displayed at the conversation interface.

An embodiment of the present disclosure provides a terminal device, comprising memory, one or more processors and a display screen; wherein the memory is used to store one or more computer-readable instructions, which perform the following acts when being executed by the one or more processors:

in response to a determination result of language inconsistency between two parties of a conversation, starting a translation function, which is used for implementing the translation of a first language into a second language;

in response to receiving an original message input by a first user in the first language, obtaining a translation message of the second language corresponding to the original message; and

displaying the translation message in a conversation interface through the display screen.

For example, the original message may be input by the first user and displayed at the conversation interface.

An embodiment of the present disclosure provides a computer-readable storage medium that stores computer-readable instructions. When the computer-readable instructions are executed by one or more processors, the one or more processors are caused to perform actions including the following:

in response to a determination result of language inconsistency between two parties of a conversation, starting a translation function, which is used for implementing the translation of a first language into a second language;

in response to receiving an original message input by a first user in the first language, obtaining a translation message of the second language corresponding to the original message; and

displaying the translation message in a conversation interface.

For example, the original message may be input by the first user and displayed at the conversation interface.

In an embodiment of the present disclosure, whether two parties of a conversation start a translation function may be decided based on a determination result for whether the languages used by the two parties of the conversation are consistent. Assuming that a first user uses a first language and a second user uses a second language, after the translation function is started, when the first user uses the first language to input an original message, a translation message of the second language corresponding to the currently input original message will be obtained simultaneously based on the translation function. As the input and translation processing of the original message are performed at the same time, the influence of translation time on the efficiency of communication between the two parties is reduced.

### BRIEF DESCRIPTION OF DRAWINGS

To describe the technical solutions in the embodiments of the present disclosure more clearly, the following briefly describes the accompanying drawings which aid in describing the embodiments. Apparently, the accompanying drawings in the following description only illustrate some example embodiments of the present disclosure, and a person of ordinary skill in the art may still derive other drawings from these accompanying drawings without creative efforts.

FIG. 1 is a flowchart of a message processing method according to an embodiment of the present disclosure;

FIG. 2 is a schematic diagram of an interface change state of translation function starting according to an embodiment of the present disclosure;

FIG. 3 is a schematic diagram of an alternative interface change state of translation function starting according to an embodiment of the present disclosure;

FIG. 4 is a schematic diagram of an interface change state after start of the translation function according to an embodiment of the present disclosure;

FIG. 5 is a schematic diagram of an interface change state of translation message editing and processing in a translation interface according to an embodiment of the present disclosure;

FIG. 6 is a schematic diagram of an interface change state of triggering of a retranslation operation in a translation interface according to an embodiment of the present disclosure;

FIG. 7 is a schematic diagram of an interface change state after triggering of a message sending operation according to an embodiment of the present disclosure;

FIG. 8 is a flowchart of an alternative message processing method according to an embodiment of the present disclosure;

FIG. 9 is a schematic diagram of an interface change state of a translation language switching process according to an embodiment of the present disclosure;

FIG. 10 is a flowchart of an alternative message processing method according to an embodiment of the present disclosure;

FIG. 11 is a schematic diagram of an interface change state of an alternative translation language switching process according to an embodiment of the present disclosure;

FIG. 12 is a schematic structure diagram of a message processing device according to an embodiment of the present disclosure;

FIG. 13 is a schematic structure diagram of a terminal device corresponding to the message processing device provided in an embodiment shown in FIG. 12.

### DETAILED DESCRIPTION

In order to make the object, technical solutions, and advantages of the embodiments of the present disclosure clearer, the technical solutions in the embodiments of the present disclosure will be described clearly and completely hereinafter in conjunction with the drawings in the embodiments of the present disclosure. Apparently, the described embodiments demonstrate a part of the embodiments of the present disclosure, rather than all embodiments. Other embodiments obtained by a person of ordinary skill in the art based on the embodiments of the present disclosure without creative efforts all fall within the protection scope of the present disclosure.

Terms used in the embodiments of the present disclosure are for the purpose of describing specific embodiments only and are not intended to limit the present disclosure. Unless otherwise noted in the context, the singular forms “a,” “an,” “the” and “said” used in the embodiments and appended claims of the present disclosure are also intended to represent plural forms thereof “A plurality of” generally includes at least two, but including at least one should not be excluded.

It should be appreciated that the term “and/or” used herein is merely an association relationship describing associated objects, indicating that there may be three relations; for example, A and/or B may indicate the following three cases: A exists individually, A and B exist simultaneously, and B exists individually. In addition, the character “I” herein generally indicates that the related objects before and after the character form an “or” relation.

Depending on the context, the term “if” as used herein may be interpreted as “when,” or “in the case that,” or “in response to a determination,” or “in response to a detection.” Similarly, depending on the context, the phrase “if determined” or “if detected (stated condition or event)” may be interpreted as “when determined” or “in response to a determination,” or “when detected (stated condition or event)” or “in response to detecting (stated condition or event).”

It should also be noted that the term “comprise,” “include,” or any other variant thereof is intended to encompass a non-exclusive inclusion, so that a product or system that involves a series of elements comprises not only those elements, but also other elements not explicitly listed, or elements that are inherent to such a product or system. Without more restrictions, an element defined by the phrase “including a . . . ” does not exclude the presence of another same element in the product or system that comprises the element.

In addition, the sequence of steps in the following method embodiments is only an example and is not to impose a strict limitation.

In the conventional techniques, when two users have a conversation through an instant messaging APP, the message receiver decides whether or not the received conversation message needs to be translated according to actual needs, and when the message receiver decides that the translation is needed, translation processing of the received conversation message is performed, resulting in poor timeliness of the receiver in obtaining the message content that the receiver can understand. For this reason, in the message processing method provided by an embodiment of the present disclosure, firstly, whether to start a translation function is automatically determined according to the consistency between the languages used by the two parties of the conversation, secondly, after the translation function is started, translation processing is performed in the sending process, that is to say, an input conversation message is translated at the same time when the message sender inputs the conversation message other than after the whole conversation message has been input and “Send” is clicked on, thereby ensuring the timeliness of translation and reducing the influence of translation time on the efficiency of communication between the two parties. Thirdly, as translation is performed in the process of sending, it provides a precondition for the message sender to intervene in the translation process. For example, the message sender can edit and process the translation result to ensure the reliability of the translation processing.

The implementation process of the message processing method provided by an embodiment of the present disclosure will be introduced below in conjunction with the following method embodiments and drawings.

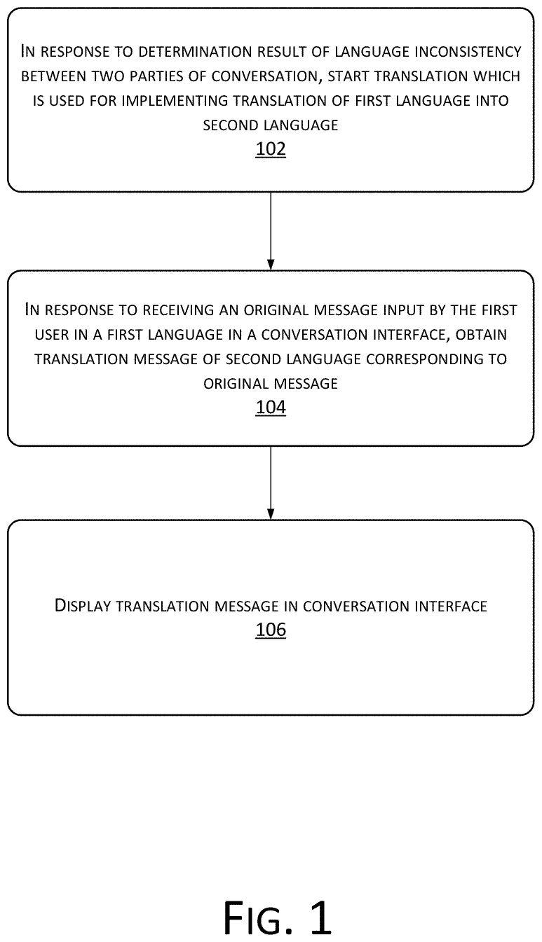

FIG. 1 is a flowchart of a message processing method according to an embodiment of the present disclosure. As shown in FIG. 1, the method may comprise the following steps:

102, in response to a determination result of language inconsistency between two parties of a conversation, starting a translation which is used for implementing the translation of a first language into a second language.

In an embodiment, the two parties of a conversation refer to a first user and a second user mentioned below. The implementing subject of the message processing method in this embodiment and other embodiments is the instant messaging APP in the terminal device of the first user.

In an alternative, the determination of whether the languages used by the two parties of a conversation are consistent can be implemented on the server side. In this case, the instant messaging APP starts the translation function in response to a determination result of language inconsistency between two parties of a conversation, which can be implemented in the following way:

receiving a translation start notice sent by a server when the server determines the first language used by the first user is inconsistent with the second language used by the second user; and

starting a translation function according to the translation start notice, i.e., starting a function, which is used for implementing the translation of the first language into the second language.

In practical applications, the time to trigger the server to start the above determination process can be as follows: When a conversation between the first user and the second user is opened, the instant messaging APP of the party who opened the conversation can send a conversation opening notice to the server. Assuming that the first user opens the conversation with the second user by finding the second user in the address book, the instant messaging APP of the first user sends a conversation opening notice to the server. The conversation opening notice can carry the identifications of the first user and the second user. Therefore, when the server receives the conversation opening notice, the server obtains a language used by the first user, which is assumed to be a first language and obtains a language used by the second user, which is assumed to be a second language. If it is found that the first language and the second language are inconsistent, the above-mentioned translation start notice can be sent to the instant messaging APP of the first user to notify the instant messaging APP to start the translation function to implement the translation of the first language into the second language. The translation start notice may contain identifications of the first language and the second language.

It is understandable that the server can also send a translation start notice to the instant messaging APP of the second user at the same time to notify the instant messaging APP of the second user to start the translation function, so as to implement the translation of the second language into the first language.

Here, the server may obtain the first language of the first user and the second language of the second user in the following way: Each user can pre-configure a language that the user usually uses and the server maintains the language that each user usually uses. Based on this, the server obtains the first language usually used by the first user and the second language usually used by the second user. Alternatively, the server obtains the first user's recent historical conversation data in a certain time range and determines a first language used by the first user according to the language frequently used by the first user in the historical conversation data. Assuming that the historical conversation data contains more than one language, the most frequently used language can be determined as the first language used by the first user. Similarly, the server can determine a second language used by the second user based on the historical conversation data of the second user.

In another alternative, the determination for whether the languages of the two parties of a conversation are consistent can be implemented by the instant messaging APP of the first user. Now, the instant messaging APP starts a translation function in response to a determination result of language inconsistency between two parties of a conversation, which can be implemented in the following way:

receiving at least one message sent by the second user;

determining that the second language corresponding to at least one message is inconsistent with the first language used by the first user and starting a translation function, i.e., starting a function, which is used for implementing the translation of the first language into the second language.

The following actual application scenario is assumed: When the second user initiates a conversation with the first user, the second user will continuously send one or more messages to the first user. After the first user receives the one or more messages, the first user will reply to the second user. Now, the instant messaging APP of the first user can determine a second language used by the second user according to the language used in the one or more messages. In addition, the instant messaging APP of the first user may locally store the usually used language preset by the first user, which is assumed to be a first language. Then if the second language sent by the instant messaging APP of the first user is inconsistent with the first language, the corresponding translation function will be started. Alternatively, if the instant messaging APP of the first user also saves the historical data of previous conversations between the second user and the first user, a second language used by the second user can also be determined according to the language often used by the second user in the historical conversation data between the second user and the first user.

Assuming that the second user used more than one languages in the foregoing at least one message or in the historical conversation data between the second user and the first user, the language with the highest use frequency can be selected from them as a second language used by the second user.

When the actual application scenario is a conversation initiated by the first user with the second user, the instant messaging APP of the first user may determine a second language used by the second user according to the messages replied by the second user or the historical data of conversations with the second user, and determine a first language used by the first user according to the usually used language preset by the first user.

For the instant messaging APP of the first user, after the translation function is started, the influence on the translation processing logic of the instant messaging APP of the first user can be seen in the following aspect: when starting the translation function, the instant messaging APP of the first user has known that it needs to translate the messages input by the first user in a specific language into another specific language, so when translation processing needs to be performed subsequently, the instant messaging APP of the first user may directly send a translation request carrying messages that need to be translated and the target language to a server corresponding to the instant messaging APP or any other server or search engine that can provide a translation function. Here, the messages that need to be translated are the original messages subsequently input by the first user in the message input area of the conversation interface, and the target language is the second language used by the second user.

The possible influence on the translation processing logic of the instant messaging APP of the first user after the translation function is started has been described above. Further, in order to improve the interface friendliness, in an example embodiment, after the translation function is started, a translation language prompt control can be displayed in the conversation interface of the instant messaging APP of the first user. The translation language prompt control carries an identification of a first language and an identification of a second language and is used to prompt a purpose of translation of the first language into the second language. The conversation interface is a conversation window in the instant messaging APP of the first user after a conversation between the first user and the second user is opened.

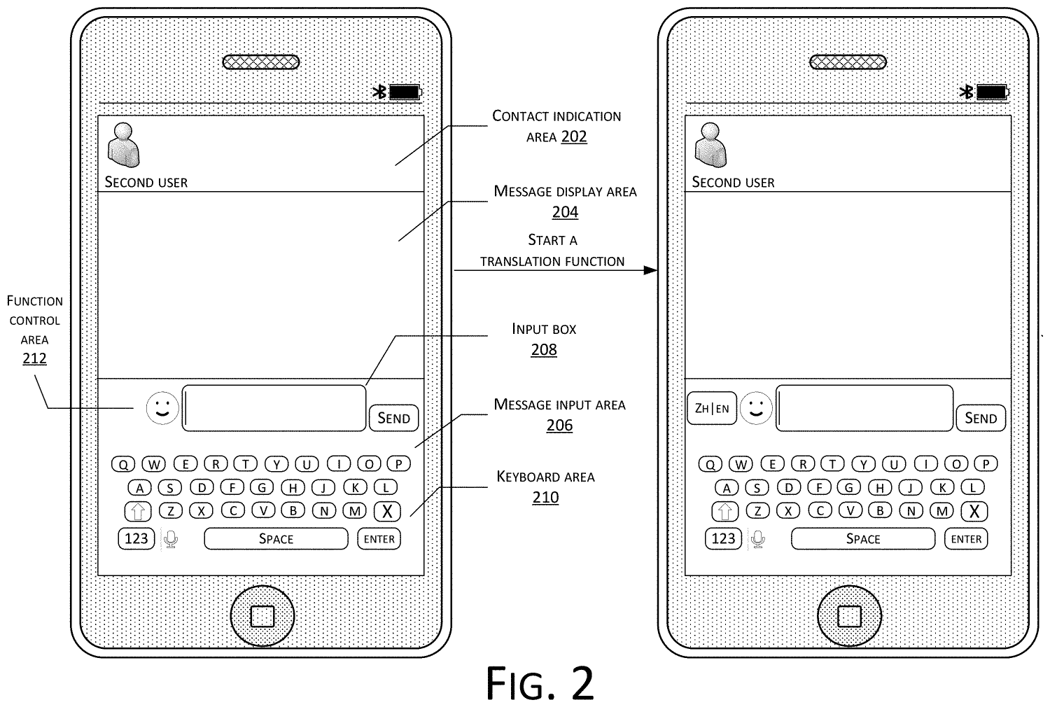

In order to intuitively understand the difference of the interface elements before and after the instant messaging APP of the first user starts the translation function, as shown in FIG. 2, FIG. 2 shows the difference before and after the translation function is started. In FIG. 2, it is assumed that the first user initiates a conversation with the second user. Now, the instant messaging APP of the first user displays the conversation interface; after the translation function is started, a translation language prompt control can be displayed in the conversation interface of the instant messaging APP of the first user, for example, the button with word zh|en as shown in FIG. 2. Assuming that the first language is Chinese and the second language is English, zh is the identification of Chinese and en is the identification of English.

As shown in FIG. 2, the conversation interface is roughly divided from top to bottom into: a contact indication area 202, a message display area 204 and a message input area 206. For the first user: the contact indication area 202 is used to display user information of a user on the opposite site, i.e., the second user, such as name and head portrait; the message display area 204 is mainly used to display the conversation messages generated during the communication between the first user and the second user; the first user can input the conversation messages of the communication with the second user through the message input area 204. For example, when the first user inputs a message in the message input area 204, an input box 208, a keyboard area 210 and a function control area 212 including some function controls, such as expression control, screenshot control and voice chat control, are often displayed in the message input area.

Based on the conversation interface structure shown in FIG. 2, the translation language prompt control can be displayed in the function control area in the message input area, or in an appropriate position in the message display area, or in an appropriate position in the contact indication area. FIG. 2 shows that the translation language prompt control is displayed in the function control area in the message input area.

Further, in the aforementioned alternatives, the instant messaging APP of the first user can automatically start the translation function immediately based on the determination result of the language inconsistency between the first user and the second user. However, in another alternative, before starting the translation function, the instant messaging APP of the first user may also display a translation start prompt message in the conversation interface at first based on the determination result of the language inconsistency between the two parties of the conversation to prompt the first user whether or not to start the translation function, and then, in response to a translation function start operation triggered by the first user according to the translation start prompt message, the instant messaging APP of the first user starts the translation function. In other words, the first user can decide at discretion whether to start the translation function from the first language to the second language based on the determination result of the language inconsistency between the two parties of the conversation.

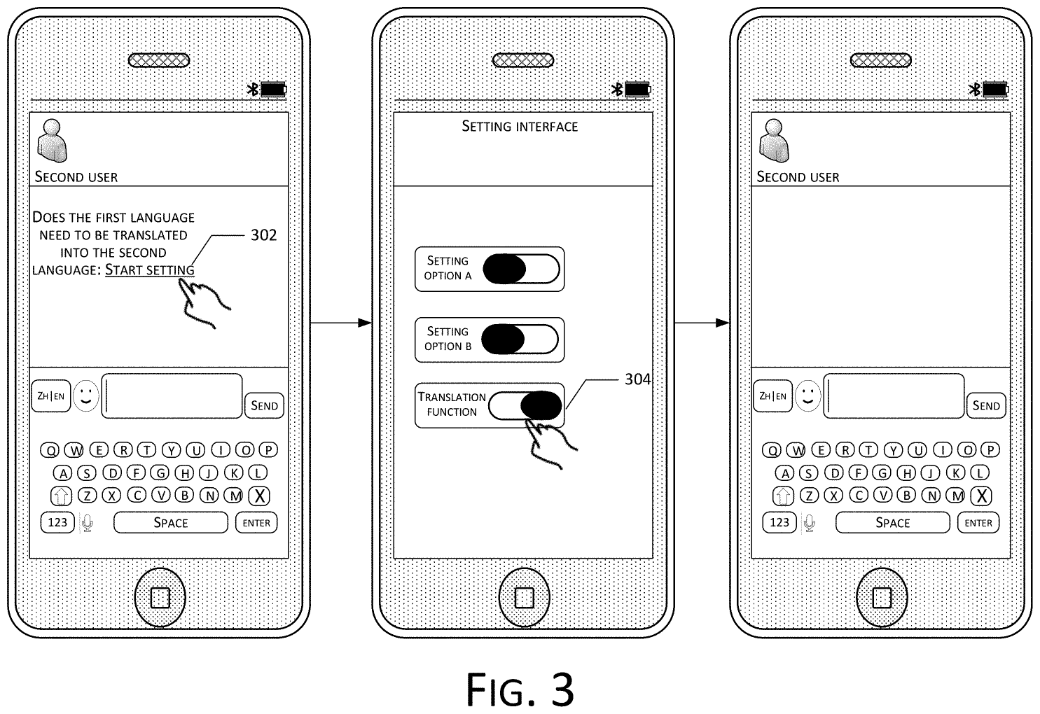

As shown in FIG. 3, assuming that the first user initiates a conversation with the second user, a conversation interface is displayed in the instant messaging APP of the first user now. When the instant messaging APP of the first user determines at discretion or based on a translation start notice from a server that the languages of the first user and the second user are inconsistent, a translation start prompt message is displayed in the conversation interface. Here, the translation start prompt message may include content such as “Does the first language need to be translated into the second language” and may also include a translation function setting control. As shown in FIG. 3, for example, the translation function setting control is, for example, a link with the words “Start setting” 302. After the first user clicks on the link, a setting interface pops up. The setting interface contains a plurality of setting options. One of them is a “translation function” start setting option 304. The start setting option is in a state of not starting the translation function by default. The user can trigger the translation function start operation by operating this start setting option, thereby starting the translation function. For example, as shown in FIG. 3, the user can slide the button to right to trigger the translation function.

Certainly, the above-mentioned translation function setting control is only an example. In actual applications, for example, Start and Not Start options can be set directly in a translation start prompt message, so that the user can directly select the two options.

As shown in FIG. 3, after a user triggers and starts a translation function, a translation language prompt control can be displayed in a conversation interface in the instant messaging APP of the first user, for example, a button with word zh|en as shown in FIG. 3.

104, in response to receiving an original message input by the first user in a first language in a conversation interface, obtaining a translation message of a second language corresponding to the original message.

106, displaying the translation message in the conversation interface.

After the translation function is started, while a conversation message input by the first user is called an original message, the translation function can be used to translate the input original message into a second language.

For example, the first user can use the first language to input the original message in the input box of the conversation interface. With the input by the first user, the instant messaging APP of the first user will obtain in real time a translation message of the second language corresponding to the original message and display the translation message in the conversation interface.

It should be noted that when the first user inputs the original message, there may be occasional input in other languages other than the first language. In this case, for example, the content input in the non-first language may be left not translated, or, for example, if the instant messaging APP of the first user or the server supports the translation function of the non-first language into the second language, the instant messaging APP of the first user or the server may also translate the content input in the non-first language.

For example, the instant messaging APP of the first user can trigger a translation request after recognizing that the first user inputs a word or a phrase word, or a few words or a few phrases. The translation request includes the original message and the identification of the second language that already exist in the input box at the moment, and even may include the identification of the first language. The translation request is sent to a translator, such as a server of the instant messaging APP, or any other server that provides a translation function. After receiving a translation message fed back from the translator, the translation message is displayed in the conversation interface.

In actual applications, the display position and display mode of the translation message in the conversation interface can be preset, for example, the translation message can be directly displayed in the form of text in an appropriate position in the conversation interface.

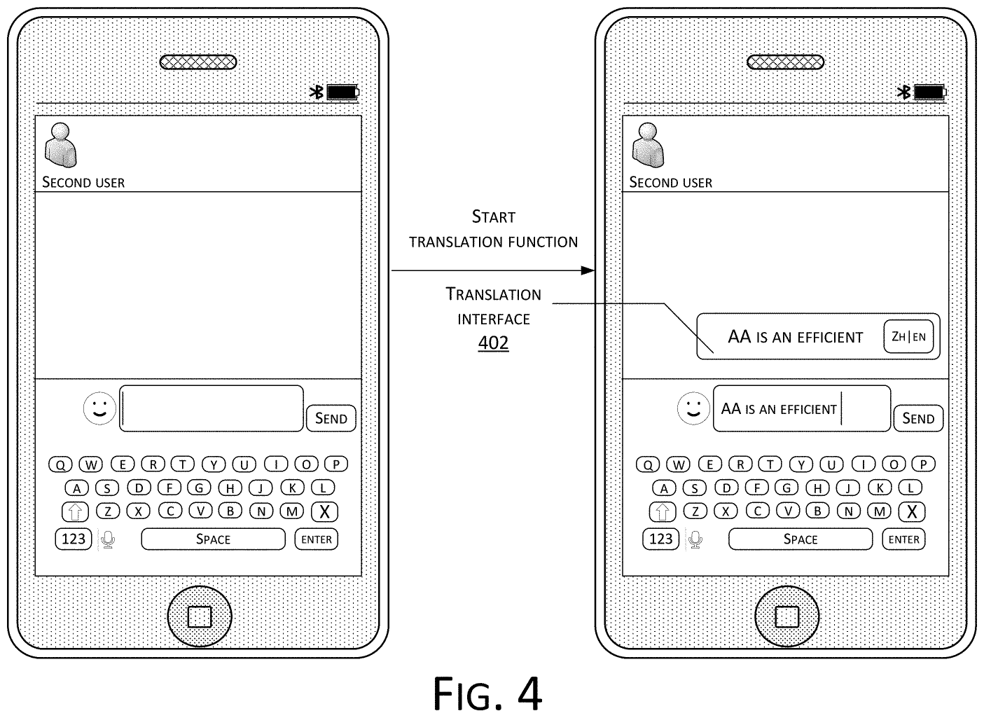

In an example embodiment, as shown in FIG. 4, after the instant messaging APP of the first user starts the foregoing translation function, a translation interface 402 is displayed in the conversation interface in a floating manner. The translation interface is used to carry translation messages. For example, the translation language prompt control mentioned in the foregoing embodiment can be displayed on the translation interface in a superimposed manner, as shown in FIG. 4. When the first user inputs an original message in the input box, the visual focus of the first user is on the input box. Therefore, in order to match the current visual focus of the first user, the translation interface can be displayed over the input box. Thus, as shown in FIG. 4, when the first user subsequently begins to input an original message into the input box, with the input of the original message, a translation message corresponding to the original message will be adaptively displayed in the translation interface.

In an example embodiment, in order to ensure the user-friendliness of the conversation interface, the maximum number of lines that can be displayed in the translation interface can also be preset. Therefore, for an original message currently input by the first user in the input box, in the process of displaying a corresponding translation message in the translation interface, if the number of lines of the obtained translation message displayed in the translation interface has reached the preset line number, then the display of the subsequent translation message in the translation interface will be stopped or the translation message first displayed will be removed from the translation interface so that the subsequent translation message can be displayed in the translation interface. When the text quantity of an original message input by the first user in the input box continues to increase, the text quantity of the translation message also increases. When the obtained translation message has reached the number of lines limited by the translation interface, the subsequently obtained translation message will no longer be displayed in the translation interface.

Further, for example, in addition to the setting of the maximum number of displayed lines, the translation interface can also be preset with display animation, so that when a translation message is presented in the translation interface, the translation interface can present the corresponding display animation. For example, when the first user inputs the original message and the pause time reaches a certain threshold, the display animation can be paused, or, when the first user triggers a message sending operation for the original message, the display animation can also be paused.

In addition, when the translation interface is provided in the conversation interface, for example, the first user can also trigger a translation closing operation to the translation interface, so that the instant messaging APP of the first user can close the started translation function based on the translation closing operation. For example, the translation closing operation can be that the first user triggers a sliding operation to the translation interface in a preset direction, such as a right-to-left sliding operation. The translation closing operation can also be the preset number of clicks of the first user on the translation interface, etc. It is understandable that after the first user triggers the translation closing operation and closes the translation function, the original message subsequently input by the first user will not be subjected to translation processing into the second language. The way to close the translation function is not limited to the above-mentioned way of performing a presetting operation of the translation interface.

In an embodiment of the present disclosure, as the translation processing is performed on the sender side of the original message, i.e., the side of the first user, it provides a possibility for the first user to intervene in the translation process. The human intervention can be, for example, that the first user can edit the translation message; it can also be that the first user triggers a retranslation operation when the first user thinks that the translation message is wrong or is currently unavailable due to network abnormality or other reasons.

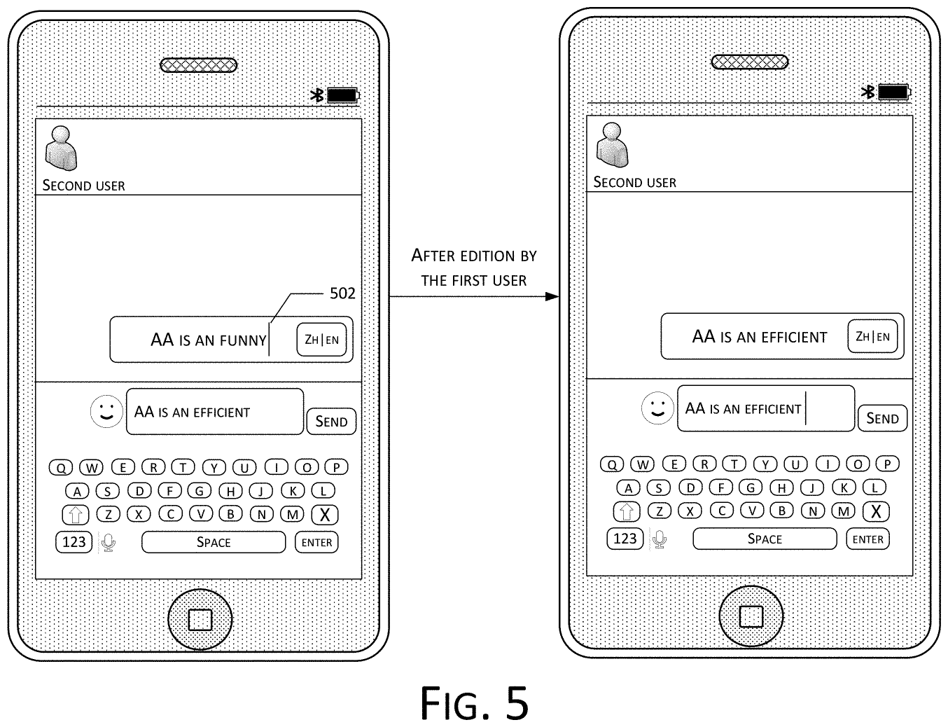

Therefore, for the instant messaging APP of the first user, in response to the editing operation triggered by the first user, the instant messaging APP of the first user executes the editing operation of the translation message performed by the first use. As shown in FIG. 5, taking the translation message displayed in the translation interface as an example, when the first user finds an error in the translation message displayed in the translation interface, such as a spelling error in an English word, the first user can place the cursor 502 at the error and then correct the misspelled English word. The editing operations that the first user can perform on the translation message may include not only error correction but also include highlighting part of the translation message, modifying the font color and font size used by the translation message, and so on.

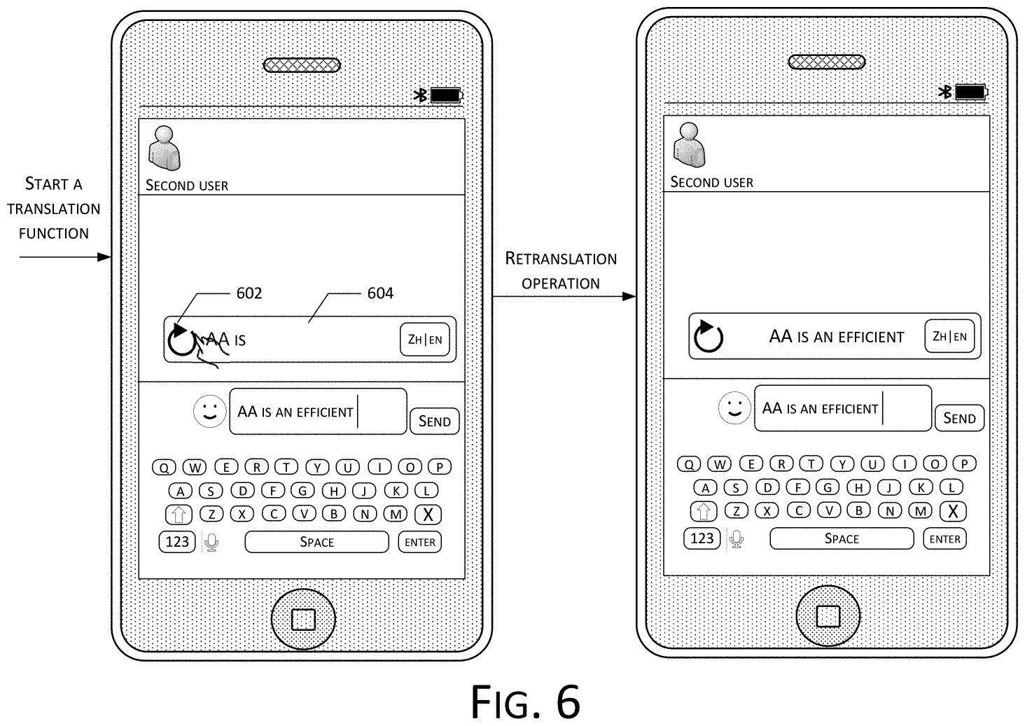

Further, as mentioned above, in actual applications, the translation result may be seriously wrong or the translation message is not available currently for some reasons. In this case, the conversation interface may also include a retranslation control, so that the instant messaging APP of the first user re-obtains a translation message of the second language corresponding to the original message in response to the first user's triggering of the retranslation control, thereby displaying the re-obtained translation message. As shown in FIG. 6, for example, in order to improve the friendliness and conciseness of the interface, the retranslation control 602 is displayed on a side of the translation interface 604, such as the curved arrow shown in FIG. 6.

After step 106, for example, the following step may also be included:

in response to a message sending operation triggered by the first user, sending the translation message to the second user; or in response to a message sending operation triggered by the first user, displaying the original message and the translation message in the conversation interface in a preset display style.

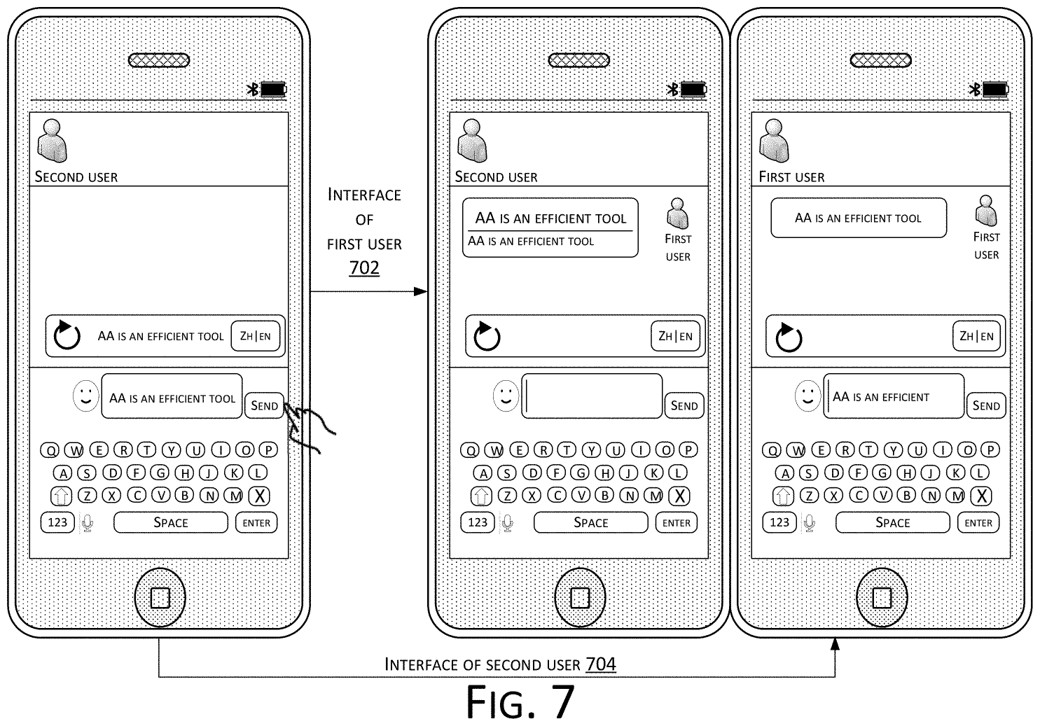

For example, when the first user finishes inputting the current original message in the input box and then clicks on the send button as shown in FIG. 7 to trigger a message sending operation, the translation message corresponding to the original message will be sent to the second user. The translation information will be displayed in the conversation interface of the instant messaging APP of the second user, as shown in FIG. 7. For the instant messaging APP of the first user, the instant messaging APP of the first user displays the original message input by the first user and the translation message corresponding to the original message in the conversation interface of the instant messaging APP of the first user 702 in a preset display style, such as in the message display area, as shown in FIG. 7. The preset display style is generating a message card containing the original message and the translation message, which are separated by a horizontal line in the card, with the translation message above the horizontal line and the original message below the horizontal line. Certainly, the display style is only an example, and in fact it is not limited to this display style. In fact, a plurality of example display styles can also be provided in advance so that the first user chooses a desired display style. AT the interface of the instant messaging APP of the second user 704, the translation message is displayed.

In summary, in the message processing method provided by an embodiment of the present disclosure, whether or not to start a translation function can be automatically determined according to whether the languages of the two parties of a conversation are consistent. After the translation function is started, the translation processing is performed in the sending process. That is to say, while the message sender is inputting a conversation message, the input conversation message is translated, which ensures the timeliness of translation, reducing the influence of translation time on the efficiency of communication between the two parties and causing the receiver to directly obtain a translation message in a language that the receiver can understand. Further, as the translation processing is performed in the sending process, it provides a precondition for the message sender to intervene in the translation process. For example, the message sender can edit the translation result to ensure the reliability of the translation processing.

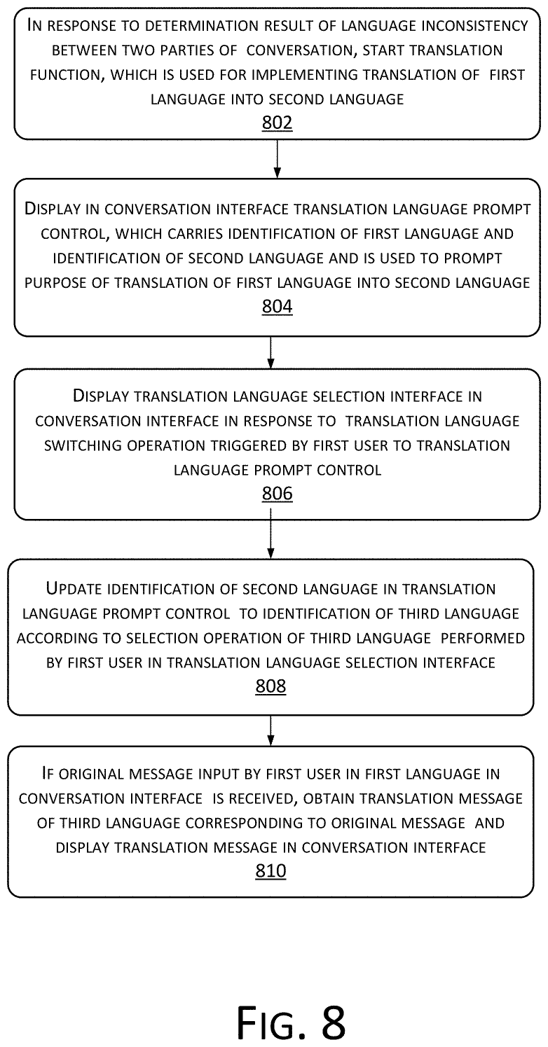

FIG. 8 is a flowchart of an alternative message processing method according to an embodiment of the present disclosure. As shown in FIG. 8, the method includes the following steps:

802, in response to a determination result of language inconsistency between two parties of a conversation, starting a translation function, which is used for implementing the translation of a first language into a second language.

804, displaying in the conversation interface a translation language prompt control, which carries an identification of a first language and an identification of a second language and is used to prompt a purpose of translation of the first language into the second language.

The above steps can refer to the description in the foregoing relevant embodiments and are not described herein.

In the embodiment, a circumstance where the first user can switch the translation language is mainly introduced: when the instant messaging APP of the first user starts a translation function for implementing translation of a first language into a second language based on a determination result of inconsistency between the first language used by the first user and the second language used by the second user, it is likely that the first user now does not want to translate the first language into the second language. In this case, the first user may trigger a translation language switching operation.

806, displaying a translation language selection interface in the conversation interface in response to a translation language switching operation triggered by the first user to the translation language prompt control.

808, updating the identification of the second language in the translation language prompt control to an identification of a third language according to a selection operation of the third language performed by the first user in the translation language selection interface.

810, if an original message input by the first user in the first language in the conversation interface is received, obtaining a translation message of the third language corresponding to the original message and displaying the translation message in the conversation interface.

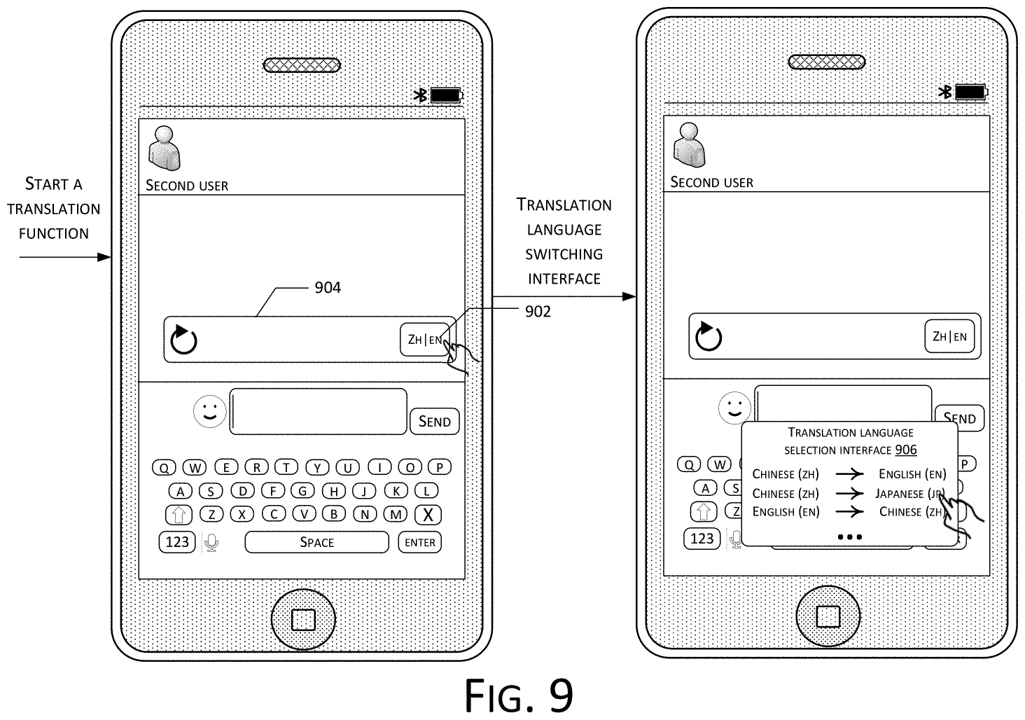

As shown in FIG. 9, it is assumed that the first language is Chinese, expressed with zh; the second language is English, expressed with en; and the third language is Japanese, expressed with jp. After the translation function of the first language into the second language is started, a translation language prompt control 902—a button with word “zh|en” is displayed in the conversation interface of the instant messaging APP of the first user. For example, as shown in FIG. 9, the translation language prompt control 902 is displayed on a side of the translation interface 904. When the first user clicks on the translation language prompt control 902, a translation language selection interface 906 is displayed in the message input area of the conversation interface or in other positions. A plurality of translation options may be contained in the translation language selection interface and each translation option can be expressed in a pattern of language A→language B, which means a translation from language A to language B can be implemented. Therefore, when the first user wants to implement a translation from the first language into the third language, the first user may select a corresponding translation option. Consequently, based on the selection of the first user, the word “zh|en” in the translation language prompt control displayed in the conversation interface will be updated to a word “zh|jp.”

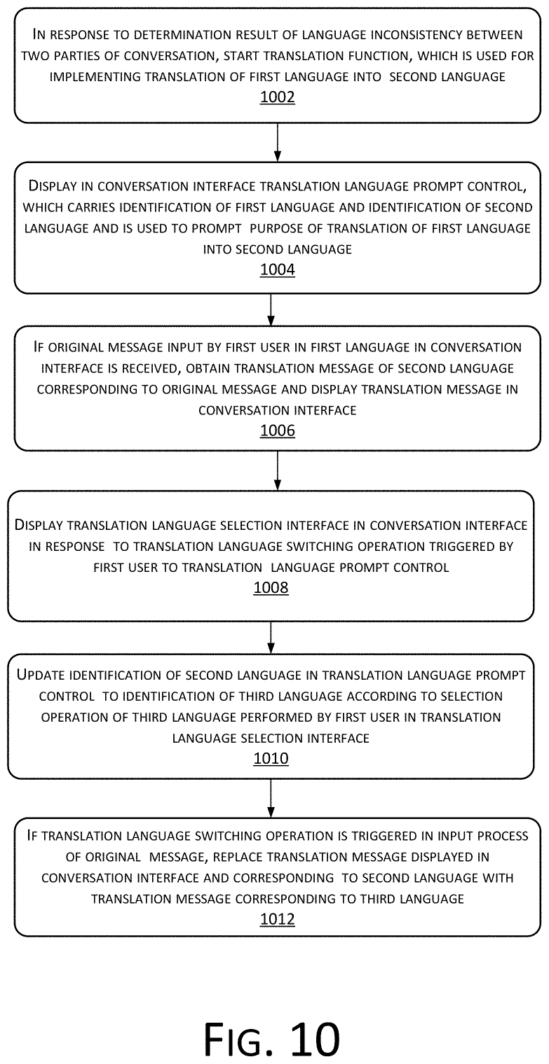

FIG. 10 is a flowchart of an alternative message processing method according to an embodiment of the present disclosure. As shown in FIG. 10, the method includes the following steps:

1002, in response to a determination result of language inconsistency between two parties of a conversation, starting a translation function, which is used for implementing the translation of a first language into a second language.

1004, displaying in the conversation interface a translation language prompt control, which carries an identification of a first language and an identification of a second language and is used to prompt a purpose of translation of the first language into the second language.

1006, if an original message input by first user in the first language in the conversation interface is received, obtaining a translation message of the second language corresponding to the original message and displaying the translation message in the conversation interface.

The above steps can refer to the description in the foregoing relevant embodiments and are not described herein.

1008, displaying a translation language selection interface in the conversation interface in response to a translation language switching operation triggered by the first user to the translation language prompt control.

1010, updating the identification of the second language in the translation language prompt control to an identification of a third language according to a selection operation of the third language performed by the first user in the translation language selection interface.

1012, if the translation language switching operation is triggered in the input process of an original message, replacing the translation message displayed in the conversation interface and corresponding to the second language with a translation message corresponding to a third language.

In the embodiment, a circumstance where the first user can switch the translation language is mainly introduced: different from the translation language switching operation triggered by the first user before inputting a first original message as shown in FIG. 9, the embodiment introduces a circumstance of triggering a translation language switching operation when the first user is inputting the first original message in the input box or has completed translation processing of one or more original messages into the second language.

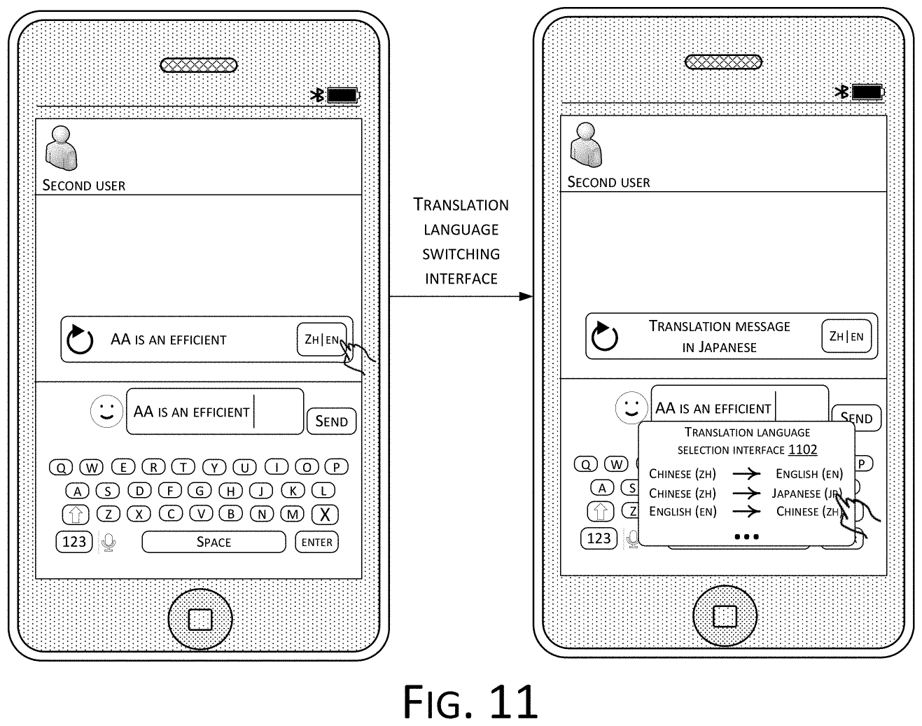

Under this circumstance, as shown in FIG. 11, it is assumed that the first language is Chinese, expressed with zh; the second language is English, expressed with en; and the third language is Japanese, expressed with jp. If the first user triggers a translation language switching operation in a process of normal input of an original message and a translation option of translation from a first language into a third language is selected in the displayed translation language selection interface 1102, then word “zh|en” displayed in the conversation interface and existing in the translation language prompt control is updated to word “zh|jp,” and a translation message corresponding to the second language and displayed in the conversation interface is replaced with a translation message corresponding to a third language. It is understandable that the original messages input by the first user thereafter all will be translated into the third language.

Message processing devices provided in one or more embodiments of the present disclosure will be described in detail below. Those skilled in the art can understand that these message processing devices all can be configured using commercial hardware components through the steps taught in this solution.

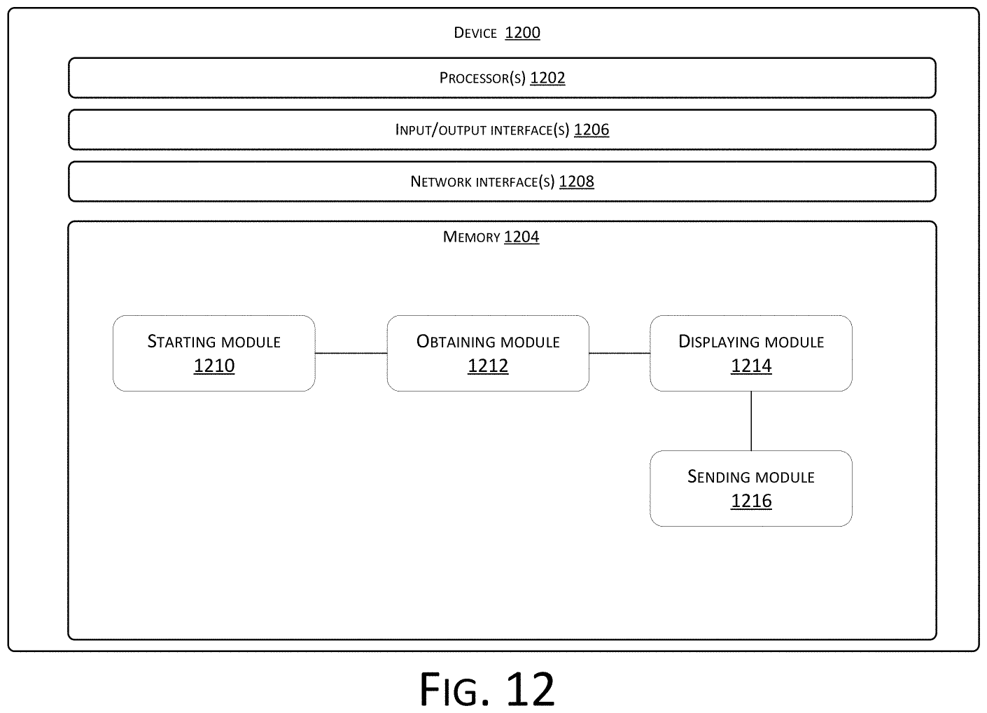

FIG. 12 is a structural schematic diagram of a message processing device according to an embodiment of the present disclosure. As shown in FIG. 12, the device 1200 includes one or more processor(s) 1202 or data processing unit(s) and memory 1204. The device 1200 may further include one or more input/output interface(s) 1206 and one or more network interface(s) 1208.

The memory 504 is an example of computer-readable media. The memory 504 may store therein a plurality of modules or units including a starting module 1210, an obtaining module 1212 and a displaying module 1214.

The starting module 1210 is used for starting a translation function, which is used for implementing the translation of a first language into a second language, in response to a determination result of language inconsistency between two parties of a conversation.

The obtaining module 1212 is used for obtaining a translation message of the second language corresponding to the original message if an original message input by a first user in a first language in the conversation interface is received.

The displaying module 1214 is used for displaying the translation message in the conversation interface.

For example, the device 1200 may further comprise a sending module 1216 stored in the memory 1204.

The sending module 1216 is used for sending the translation message to the second user in response to a message sending operation triggered by the first user.

For example, the device further comprises a receiving module, used for receiving at least one message sent by the second user. Accordingly, the starting module 1210 can be used for determining the second language corresponding to the at least one message is inconsistent with the first language used by the first user and starting the translation function.

For example, the receiving module may be further used for receiving a translation start notice sent by a server. The translation start notice is sent when the server determines the first language used by the first user is inconsistent with the second language used by the second user. Accordingly, the starting module 1210 can be used for starting the translation function according to the translation start notice.

For example, the displaying module 1214 may be further used for displaying a translation start prompt message in the conversation interface, which is used to prompt the first user whether or not the translation function is started. The starting module 1210 may be further used for starting the translation function in response to a translation function start operation triggered by the first user according to the translation start prompt message.

For example, the displaying module 1214 may be further used for displaying the translation interface in the conversation interface in a floating manner and displaying the translation message in the translation interface.

For example, the device may further comprise a closing module, used for closing the translation function in response to a translation closing operation triggered by the first user to the translation interface.

For example, the displaying module 1214 may be further used for stopping the display of the subsequent translation message in the translation interface or removing the translation message first displayed from the translation interface so that the subsequent translation message can be displayed in the translation interface if the number of lines of the obtained translation message displayed in the translation interface has reached the preset line number.

For example, the device may further comprise an editing module, used for performing an editing operation of the translation message by the first user.

For example, the editing module may be further used for performing an editing operation of the translation message by the first user in the translation interface.

For example, the conversation interface further comprises a retranslation control, and the obtaining module 1212 may be further used for re-obtaining a translation message of the second language corresponding to the original message in response to the first user's triggering of the retranslation control.

For example, the displaying module 1214 may be further used for displaying the original message and the translation message in the conversation interface in a preset display style in response to a message sending operation triggered by the first user.

For example, the displaying module 1214 may be further used for displaying in the conversation interface a translation language prompt control, which carries an identification of the first language and an identification of the second language and is used to prompt a purpose of translation of the first language into the second language; displaying a translation language selection interface in the conversation interface in response to a translation language switching operation triggered by the first user; updating the identification of the second language in the translation language prompt control to an identification of a third language according to a selection operation of the third language performed by the first user in the translation language selection interface; and if the translation language switching operation is triggered in the input process of an original message, replacing the translation message displayed in the conversation interface and corresponding to the second language with a translation message corresponding to the third language.

The device shown in FIG. 12 can perform the message processing methods provided by the foregoing embodiments. The part not described in detail in this embodiment may refer to relevant description of the foregoing embodiments. The implementation process and technical effects of this technical solution may refer to the description of the foregoing embodiments and are not described here.

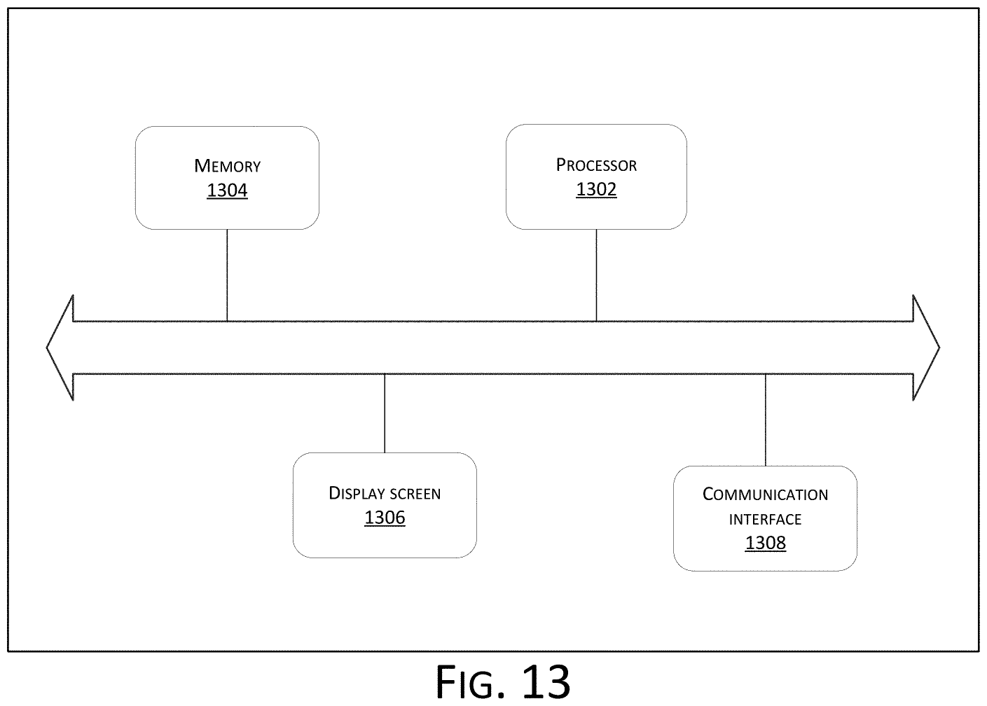

The internal function and structure of the message processing device have been described above. In a possible design, the structure of the message processing device may be implemented as a terminal device, which for example is a mobile phone, tablet PC or any other terminal device of the first user. As shown in FIG. 13, the terminal device may comprise a processor 1302, a memory 1304 and a display screen 1306. The memory 1304 is used to store a program that supports the message processing methods provided in the foregoing embodiments by the terminal device, and the processor 1302 is configured to execute the program stored in the memory 1304.

The program includes one or more computer-readable instructions, which can achieve the following steps when being executed by the processor 1302:

in response to a determination result of language inconsistency between two parties of a conversation, starting a translation function, which is used for implementing the translation of a first language into a second language;

if an original message input by a first user in a first language in the conversation interface is received, obtaining a translation message of the second language corresponding to the original message; and

displaying the translation message in the conversation interface through a display screen 1306.

For example, the terminal device may further comprise a communication interface 1308.

Therefore, for example, the processor 1302 may be further used for sending the translation message to the second user via the communication interface 1308 in response to a message sending operation triggered by the first user.

For example, the processor 1302 may be further used to implement all or some of the steps in the foregoing embodiments.

Further, an embodiment of the present disclosure provides computer-readable storage media storing computer-readable instructions. When the computer-readable instructions are executed by a processor, the processor is caused to perform actions including the following:

in response to a determination result of language inconsistency between two parties of a conversation, starting a translation function, which is used for implementing the translation of a first language into a second language;

if an original message input by a first user in a first language in the conversation interface is received, obtaining a translation message of the second language corresponding to the original message; and

displaying the translation message in the conversation interface.

Further, when the computer-readable instructions are executed by a processor, the processor may also be caused to perform all or some of the steps involved in the message processing method in the foregoing embodiments.

The device embodiments described above are only examples, wherein the units described as separate components may or may not be physically separated; and the components displayed as units may or may not be physical units; that is, the units may be located in one place, or may be distributed on a plurality of network units. Some or all of the modules may be selected according to actual needs to achieve the object of the solution of the embodiments. Those of ordinary skill in the art may understand and implement the embodiments without creative efforts.

Through the description of the above implementations, those skilled in the art may clearly understand that each implementation may be realized by means of a necessary general hardware platform, and may certainly be implemented by a combination of hardware and software. Based on such an understanding, the above technical solutions or the part of the technical solution, which is essential or contributes to the conventional techniques, can be embodied in the form of a software product. The present disclosure may take the form of a computer program product which is embodied on one or more computer-usable storage media (including, but not limited to, disk storage, CD-ROM, optical storage, and so forth) having computer-usable program code included therein.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct the computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or another programmable device to generate computer-implemented processing. Therefore, the instructions executed on the computer or another programmable device are used to provide steps for implementing a specific function in one or more processes in the flowcharts and/or in one or more blocks in the block diagrams.

In one typical configuration, a computer device comprises one or a plurality of processing units (CPUs), input/output interfaces, network interfaces, and memory.

A memory may include a volatile storage device on a computer-readable medium, a random-access memory (RAM), and/or a non-volatile memory, such as a read-only memory (ROM), or a flash memory (flash RAM). A memory is an example of the computer-readable medium.

Computer-readable media include both permanent and non-permanent, removable and non-removable media, and may store information by any method or technology. The information may be a computer-readable instruction, a data structure, a module of a program, or other data. Examples of computer storage media include, but are not limited to, a phase change memory (PRAM), a static random access memory (SRAM), a dynamic random access memory (DRAM), other types of random access memories (RAMs), a read only memory (ROM), an electrically erasable programmable read-only memory (EEPROM), a flash memory or other memory technologies, a compact disk read-only memory (CD-ROM), a digital versatile disc (DVD) or other optical storage devices, a cassette type magnetic tape, a magnetic tape/magnetic disk storage or other magnetic storage devices or any other non-transmission medium, and may be used for storing information accessible by computing devices. As defined herein, the computer-readable media do not include transitory media, such as modulated data signals and carriers.

Finally, it should be noted that the above embodiments are merely used for illustrating, rather than limiting, the technical solutions of the present disclosure. Although the present disclosure is described in detail with reference to the aforementioned embodiments, it should be understood by those of ordinary skill in the art that modifications may still be made to the technical solutions described in the aforementioned embodiments, or equivalent substitutions may be applied to part of the technical features therein; and these modifications or substitutions do not cause the essence of corresponding technical solutions to depart from the spirit and scope of the technical solutions in the embodiments of the present disclosure.

The present disclosure may further be understood with clauses as follows.

Clause 1. A message processing method, wherein the message processing method comprises:

in response to a determination result of language inconsistency between two parties of a conversation, starting a translation function, which is used for implementing the translation of a first language into a second language;

if an original message input by a first user in a first language in the conversation interface is received, obtaining a translation message of the second language corresponding to the original message; and

displaying the translation message in the conversation interface.

Clause 2. The method according to clause 1, wherein the in response to a determination result of language inconsistency between two parties of a conversation, starting a translation function comprises:

receiving at least one message sent by the second user; and

determining the second language corresponding to the at least one message is inconsistent with the first language used by the first user and starting the translation function.

Clause 3. The method according to clause 1, wherein the in response to a determination result of language inconsistency between two parties of a conversation, starting a translation function comprises:

receiving a translation start notice sent by a server when the server determines the first language used by the first user is inconsistent with the second language used by the second user; and

starting the translation function according to the translation start notice.

Clause 4. The method according to any one of clauses 1 to 3, wherein before the starting the translation function, the method further comprises:

displaying a translation start prompt message in the conversation interface, which is used to prompt the first user whether or not the translation function has started; and

starting the translation function in response to a translation function start operation triggered by the first user according to the translation start prompt message.

Clause 5. The method according to clause 1, wherein after the in response to a determination result of language inconsistency between two parties of a conversation, starting a translation function, the method further comprises:

displaying the translation interface in the conversation interface in a floating manner;

the displaying the translation message in the conversation interface, comprising:

displaying the translation message in the translation interface.

Clause 6. The method according to clause 5, wherein the method further comprises:

closing the translation function in response to a translation closing operation triggered by the first user to the translation interface.

Clause 7. The method according to clause 5, wherein the displaying the translation message in the translation interface comprises:

stopping the display of the subsequent translation message in the translation interface or removing the translation message first displayed from the translation interface so that the subsequent translation message can be displayed in the translation interface if the number of lines of the obtained translation message displayed in the translation interface has reached the preset line number.

Clause 8. The method according to clause 5, wherein the method further comprises:

performing an editing operation of the translation message by the first user in the translation interface.

Clause 9. The method according to clause 1, wherein the method further comprises:

performing an editing operation of the translation message by the first user.

Clause 10. The method according to clause 1, wherein the conversation interface further comprises a retranslation control and the method further comprises:

re-obtaining a translation message of the second language corresponding to the original message in response to the first user's triggering of the retranslation control.

Clause 11. The method according to clause 1, wherein the method further comprises:

in response to a message sending operation triggered by the first user, sending the translation message to the second user.

Clause 12. The method according to clause 1, wherein the method further comprises:

in response to a message sending operation triggered by the first user, displaying the original message and translation message in the conversation interface in a preset display style.

Clause 13. The method according to clause 1, wherein after starting the translation function, the method further comprises:

displaying in the conversation interface a translation language prompt control, which carries an identification of the first language and an identification of the second language and is used to prompt a purpose of translation of the first language into the second language.

Clause 14. The method according to clause 13, wherein the method further comprises:

displaying a translation language selection interface in the conversation interface in response to a translation language switching operation triggered by the first user to the translation language prompt control; and

updating the identification of the second language in the translation language prompt control to an identification of a third language according to a selection operation of the third language performed by the first user in the translation language selection interface.

Clause 15. The method according to clause 14, wherein the method further comprises:

if the translation language switching operation is triggered in the input process of an original message, replacing the translation message displayed in the conversation interface and corresponding to the second language with a translation message corresponding to the third language.

Clause 16. A message processing device, wherein the message processing device comprises:

a starting module, used for starting a translation function, which is used for implementing the translation of a first language into a second language, in response to a determination result of language inconsistency between two parties of a conversation;

an obtaining module, used for obtaining a translation message of the second language corresponding to the original message if an original message input by a first user in a first language in the conversation interface is received; and

a displaying module, used for displaying the translation message in the conversation interface.

Clause 17. A terminal device, comprising a memory, a processor and a display screen, wherein the memory is used to store one or more computer-readable instructions, which achieve the following when being executed by the processor:

in response to a determination result of language inconsistency between two parties of a conversation, starting a translation function, which is used for implementing the translation of a first language into a second language;

if an original message input by a first user in a first language in the conversation interface is received, obtaining a translation message of the second language corresponding to the original message; and

displaying the translation message in the conversation interface through a display screen.

What is claimed is:

1. A method comprising:
in response to a determination result of language inconsistency between two parties of a conversation, starting a translation of a first language into a second language;
receiving an original message input in the first language;
obtaining a translation message of the second language corresponding to the original message; and
displaying the translation message in a conversation interface.

2. The method of claim 1, wherein the receiving an original message input in the first language comprises:
receiving an original message input in the first language from a first user; and
displaying the original message at the conversation interface.

3. The method according to claim 1, wherein the in response to the determination result of language inconsistency between the two parties of the conversation, starting the translation of the first language into the second language comprises:
receiving at least one message from the second user; and
determining the second language corresponding to the at least one message is inconsistent with the first language used by the first user.

4. The method according to claim 1, wherein the in response to the determination result of language inconsistency between the two parties of the conversation, starting the translation of the first language into the second language comprises:
receiving a translation start notice; and
starting the translation according to the translation start notice.

5. The method according to claim 4, wherein the translation start notice is sent by a server when the server determines the first language used by the first user is inconsistent with the second language used by the second user.

6. The method according to claim 1, wherein before the starting the translation, the method further comprises:
displaying a translation start prompt message in the conversation interface; and
starting the translation in response to a translation function start operation triggered by the first user according to the translation start prompt message.

7. The method according to claim 1, wherein the in response to the determination result of language inconsistency between the two parties of the conversation, starting the translation of the first language into the second language comprises:
displaying a translation interface in the conversation interface in a floating window.

8. The method according to claim 1, wherein the displaying the translation message in the conversation interface comprises:
displaying the translation message in a translation interface.

9. The method according to claim 8, further comprising:
closing the translation in response to a translation closing operation triggered by the first user to the translation interface.

10. The method according to claim 8, wherein the displaying the translation message in the translation interface comprises:
determining that a number of lines of the translation message displayed in the translation interface has reached a preset line number; and
stopping a display of a subsequent translation message in the translation interface.

11. The method according to claim 8, wherein the displaying the translation message in the translation interface comprises:
determining that a number of lines of the translation message displayed in the translation interface has reached a preset line number; and
removing the translation message first displayed from the translation interface.

12. The method according to claim 8, further comprising:
performing an editing operation of the translation message by the first user in the translation interface.

13. The method according to claim 1, further comprising:
displaying the original message and translation message in the conversation interface in a preset display style.

14. The method according to claim 1, wherein after starting the translation, the method further comprises:
displaying, in the conversation interface, an identification of the first language and an identification of the second language to prompt a translation of the first language into the second language.

15. The method according to claim 14, further comprising:
displaying a translation language selection interface in the conversation interface in response to a translation language switching operation request to the translation language prompt control; and
updating the identification of the second language to an identification of a third language in response to receiving a selection operation of the third language in the translation language selection interface.

16. The method according to claim 15, further comprising:
determining that the translation language switching operation is triggered in an input process of the original message; and
replacing the translation message corresponding to the second language with a translation message corresponding to the third language.

17. A device comprising:
one or more processors; and
one or more computer-readable media storing thereon computer-readable instructions that, when executed by the one or more processors, cause the one or more processors to perform acts comprising:
in response to a determination result of language inconsistency between two parties of a conversation, starting a translation of a first language into a second language;
receiving an original message input in the first language;
obtaining a translation message of the second language corresponding to the original message; and
displaying the translation message in a conversation interface.

18. The device of claim 17, wherein the receiving an original message input in the first language comprises:
receiving an original message input in the first language from a first user; and
displaying the original message at the conversation interface.

19. One or more computer-readable media storing thereon computer-readable instructions that, when executed by one or more processors, cause the one or more processors to perform acts comprising:
in response to a determination result of language inconsistency between two parties of a conversation, starting a translation of a first language into a second language;
receiving an original message input in the first language;
obtaining a translation message of the second language corresponding to the original message; and
displaying the translation message in a conversation interface.

20. The one or more computer-readable media according to claim 19, wherein the acts further comprise:
displaying the original message and translation message in the conversation interface in a preset display style.
